(19) United States
(12) Patent Application Publication
(10) Pub. No.: US 2021/0075304 A1
(43) Pub. Date: Mar. 11, 2021

(54) DEVICE AND METHOD FOR CONTROLLING THE OPERATION OF AN ELECTRIC MACHINE

(71) Applicant: ZF Friedrichshafen AG, Friedrichshafen (DE)

(72) Inventor: Joao Bonifacio, Friedrichshafen (DE)

(73) Assignee: ZF Friedrichshafen AG, Friedrichshafen (DE)

(21) Appl. No.: 16/642,785

(22) PCT Filed: Aug. 14, 2018
(86) PCT No.: PCT/EP2018/072029

§ 371 Date: Feb. 27, 2020

(30) Foreign Application Priority Data
Sep. 7, 2017 (DE) 10 2017 215 728.3

(51) Int. Cl. H02K 21/24; H02P 6/34; H02P 21/18

(52) U.S. Cl. CPC H02K 21/24; H02P 21/18; H02P 6/34

(57) ABSTRACT

The device contains a regulator and an actuator connected electrically to the regulator at the input side and that can be connected electrically to the electric motor at the output side. An input point is interconnected electrically between the regulator and actuator at which an electric detection signal can be input A first return unit connected in parallel to the regulator and the actuator returns a first return signal to the regulator representing a version of an output signal of the actuator transformed and processed by the first return unit. A second return unit returns a second return signal to the first return unit and/or the actuator and represents a version of the output signal of the actuator transformed by the first return unit and processed by the second return unit. The second return signal represents an angle between the rotor and the stator in the electric machine.

The present invention relates to a device and a method for controlling the operation of an electric machine.

There are model-based approaches and approaches with signal feeds for control or auto-detection in control and regulating technology. The first category is based on machine parameters, used to reconstruct the rotor position of an electric machine, for example, and the second category is based on inputting high frequency voltage signals or current signals in order to monitor the rotor position.

Based on this, the present invention creates an improved device for controlling the operation of an electric machine and an improved method for controlling the operation of an electric machine according to the independent claims. Advantageous embodiments can be derived from the dependent claims and the following description.

According to embodiments of the present invention, a sensorless control can be obtained with low frequency signal feeds and subtractive feedback filtering or subtractive return filtering, or filtering with subtractive return. A rotor position of an electric machine, e.g. a synchronous machine or a permanent magnet synchronous machine, can be determined or estimated with these embodiments, in particular at low speeds or rotational rates. Two parallel return paths can be used in particular for this. By way of example, a duality between the bandwidth and an input frequency can be circumvented with the use of subtractive feedback filtering and a hybrid voltage detection system, thus enabling a frequency input that overlaps the current bandwidth of the regulator, or can be arbitrarily close thereto without disrupting it.

According to embodiments of the present invention, it is advantageously possible to input signals with low frequencies that are arbitrarily close to a bandwidth of a regulator, or even overlapping it. It is possible to reduce losses and acoustic emissions by reducing an input frequency. Such a low frequency feed can reduce demands on current measurement devices in particular, because it is possible to generate higher current responses without affecting an acoustic behavior of the overall system. It is possible to advantageously reduce costs and increase the availability and reliability of electric drives in accordance with embodiments of the present invention. In particular, a characteristically higher bandwidth of a voltage model can also be made available at lower speeds or rotational rates using a hybrid regulator.

A device for controlling the operation of an electric machine, wherein the electric machine contains a rotor and a stator, comprises the following features:
a regulator;
an actuator, wherein the actuator is electrically connected to the regulator at the input side, and can be electrically connected to the electric machine at the output side;
a input point, wherein the input point is electrically interconnected between the regulator and the actuator, wherein an electric detection signal can be input at the input point;
a first return unit for returning a first return signal to the regulator, wherein the first return unit is connected in parallel to the regulator and the actuator, wherein the first return signal represents a version of an output signal of the actuator that has been transformed and processed by the first return unit; and
a second return unit for returning at least one second return signal to the first return unit and/or the actuator, wherein the second return unit is connected in parallel to the first return unit, wherein the second return signal represents a version of the output signal of the actuator that has been transformed by the first return unit and processed by the second return unit, wherein the second return signal represents an angle between the rotor and the stator in the electric machine.

The device can be in the form of a control circuit. The electric machine can be any type of synchronous machine, e.g. a permanent magnet synchronous motor, synchronous reluctance motor, etc., or an asynchronous machine. Control can also be understood to be regulation. The regulator can be in the form of a PI regulator or another regulator. The detection signal can be input in a variety of ways, e.g. rotating, alternating in stator coordinates, etc. The detection signal can be input additively in a signal representing an actuating variable, transmitted between the regulator and the actuator. The output signal of the actuator can represent a control variable.

According to one embodiment, the second return unit can contain a demodulation device and a model surveillance device. The demodulation device can be configured to demodulate the version of the output signal of the actuator transformed by the first return unit. The model surveillance device can be configured to generate the second return signal using at least one output signal of the demodulation device. The model surveillance device can be in the form of a hybrid monitor, a voltage model surveillance device, etc. Such an embodiment has the advantage that demodulation and filtering of the input detection signal can be carried out independently of parameters, such that knowledge of a single input frequency is sufficient for this.

The demodulation device can contain a bandpass filter centered on an input frequency of the detection signal for filtering the version of the actuator output signal transformed by the first return unit, a sign function unit connected to the bandpass filter for signal transmission, a multiplication unit connected to the bandpass filter and the sign function unit for signal transmission, and a correction unit connected to the multiplication unit for signal transmission, for using a correction factor based on the detection signal. The demodulation device can also, optionally, contain a lowpass filter connected to the correction unit for signal transmission. The demodulation device can be configured to issue an error signal. Such an embodiment has the advantage that losses and acoustic emissions, as well as demands on current measurement devices, can be reduced, and higher current responses can be used.

The model surveillance device can contain a model regulator, a delay element, and an output element. The output element can contain a phase regulating loop or a mechanical monitor. In particular, the model regulator can be a PI regulator or a similar regulator. The model surveillance device can be configured to receive an error signal from the demodulation device, a voltage signal, and a current signal in the stator coordinates. Such an embodiment has the advantage that return signals can also be reliably and precisely obtained for transient operating states of the electric machine.

According to one embodiment, the second return unit can be configured to return a third return signal to a reference signal generating unit upstream of the regulator, for generating a reference signal for the regulator and/or to a speed control unit upstream of the regulator. The third return signal can represent an angular speed of the rotor in relation to the stator of the electric machine. Such an embodiment has the advantage that a position of the rotor in relation to the stator can be reliably and precisely determined in the electric machine.

The first return unit can also contain a first signal transformer for transforming a coordinate system based on the phases of the electric machine to a stator coordinate system, a second signal transformer connected to the first signal transformer for signal transmission for transforming a stator coordinate system to a rotor coordinate system, a signal reconstruction device connected to the second signal transformer for signal transmission for reconstructing the output signal of the actuator, a third signal transformer connected to the signal reconstruction device for signal transmission for transforming a rotor coordinate system to a stator coordinate system, and a fourth signal transformer connected to the first signal transformer and the third signal transformer for signal transmission for transforming a stator coordinate system to a rotor coordinate system. The second return unit can be or is connected to the second signal transformer. Such an embodiment has the advantage that a signal response can be economically and reliably reconstructed and made available in the return path.

The signal reconstruction device can be in the form of a Kalman filter. The first return unit can be configured to subtract a version of the output signal of the actuator reconstructed by means of the signal reconstruction device from a measured version of the output signal of the actuator. Such an embodiment has the advantage that measurement errors can be reduced, estimates can be obtained for system variables that cannot be measured, and the reconstructed signal response can be easily subtracted from a measured signal.

The signal reconstruction device can also be configured to reconstruct the output signal of the actuator using an input frequency of the detection signal and a matrix stored as a reference table. Such an embodiment has the advantage that a signal reconstruction can be simplified, and computing time can be reduced.

According to one embodiment, the actuator can contain a series connection that comprises a signal transformer for transforming a rotor coordinate system into a stator coordinate system, a pulse width modulation device, and/or a converter for providing the output signal of the actuator. The signal transformer can then receive the second return signal. In other words, the signal transformer can be configured to receive the second return signal. Such an embodiment has the advantage that the output signal can then be reliably and economically provided for actuating the electric machine.

A method for controlling the operation of an electric machine, wherein the electric machine contains a rotor and a stator, is characterized in that it comprises the following steps:
inputting an electric detection signal at a input point that is electrically interconnected between a regulator and an actuator, wherein the actuator is electrically connected at the input side to the regulator, and can be electrically connected at the output side to the electric machine; and
processing an actuator output signal with a first return unit and a second return unit, wherein the first return unit is connected in parallel to the regulator and the actuator, wherein the second return unit is connected in parallel to the first return unit in order to return a first return signal from the first return unit to the regulator, wherein the first return signal represents a version of an actuator output signal transformed and processed by the first return unit, and to return at least one second return signal from the second return unit to the first return unit, and/or the actuator, wherein the second return signal represents a version of the actuator output signal transformed by the first return unit and processed by the second return unit, wherein the second return signal represents an angle between the rotor and the stator of the electric machine.

The method can be carried out in conjunction with an embodiment of the device described above. The method can also be carried out in conjunction with a control device by means of appropriate components in the control device.

A control device can be an electric device that processes electric signals, e.g. sensor signals, and outputs control signals based thereon. The control device can contain one or more suitable interfaces in the form of hardware and/or software. A hardware interface can be part of an integrated circuit, for example, in which functions of the device are implemented. The interfaces can also be individual integrated circuits, or at least comprise discrete components. A software interface can be a software module on a microcontroller, for example, along with other software modules.

A computer program product that has program code that can be stored on a machine readable medium, e.g. a solid state drive, a hard disk, or an optical memory, and used for executing the method on any of the embodiments described above, when the program is executed on a computer or a control device.

The invention shall be explained in greater detail in reference to the attached drawings. Therein:

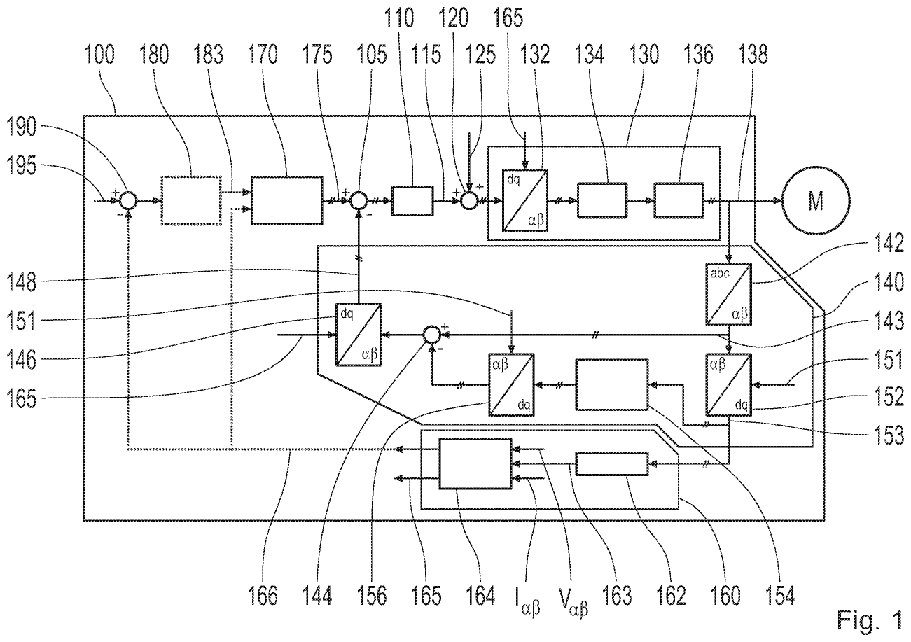

FIG. 1 shows a schematic illustration of a control device according to an exemplary embodiment of the present invention, and an electric machine;

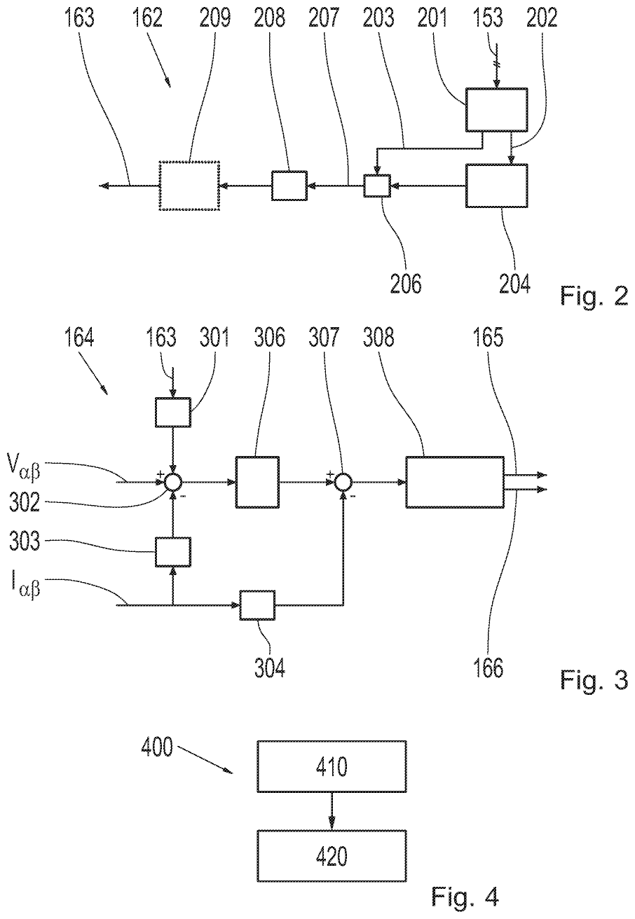

FIG. 2 shows a schematic illustration of a demodulation device in the device shown in FIG. 1;

FIG. 3 shows a schematic illustration of a model surveillance device in the device shown in FIG. 1; and

FIG. 4 shows a flow chart for a control method in accordance with an exemplary embodiment of the present invention.

Before exemplary embodiments of the present invention are explained, the background, fundamentals and advantages of exemplary embodiments shall first be examined.

Processes, methods or approaches for an auto-detection or sensorless control can be divided into two categories: model-based approaches and approaches with signal feeds. These categories can be combined according to exemplary embodiments.

Model-based approaches used machine parameters for reconstructing rotor position data. In general, such approaches are advantageous in particular for a high speed drive, and a performance can also be maintained at lower speeds or rotational rates, for example, according to exemplary embodiments, wherein it is also possible to monitor at a speed of zero. According to exemplary embodiments, stable operation is also possible in particular in a regeneration operation at a low load. In addition, a relationship between performance with this approach and the value of the machine parameter, which changes depending on the temperature, age, production tolerances, etc., can be reduced or eliminated according to exemplary embodiments.

Approaches based on inputting high frequency current signals or voltage signals are advantageous, in particular at lower speeds and a speed of zero. According to exemplary embodiments, losses due to hystereses and eddy currents, which increase with the frequency, as well as acoustic noises, which can be unacceptable in some applications, can be prevented or at least reduced, despite inputting a detection signal. In addition, an advantageous compromise between the input frequency and a maximum obtainable bandwidth for the regulator can be obtained according to exemplary embodiments due to the low frequency signal input, wherein a measured electric signal can be filtered, e.g. by means of a lowpass filter or notch filter, before it is returned to the regulator, in order to prevent interference between the signal input and the control loop. As a result, the reliability of the regulator can be increased, wherein phase distortions of a base frequency in particular can be prevented or at least reduced by a feedback filter according to exemplary embodiments.

According to exemplary embodiments, an increase in losses, a generation of acoustic noises, a parameter relationship, a loss in monitoring capability at lower speeds or rotational rates, a bandwidth limitation of a current regulator, etc. can be prevented or at least reduced for high performance applications.

In the following description of preferred exemplary embodiments of the present invention, the same or similar reference symbols shall be used for elements with similar functions shown in the figures, wherein there shall be no repetition of the descriptions of these elements.

FIG. 1 shows a schematic illustration of a control device 100 according to an exemplary embodiment of the present invention and an electric machine M. The device 100 is configured to control the operation of the electric machine M. The control device 100 according to the exemplary embodiment of the present invention shown in FIG. 1 is in the form of a control circuit. The electric machine M has a rotor and a stator. According to the exemplary embodiment of the present invention shown in FIG. 1, the electric machine M is a synchronous machine, in particular a permanent magnet synchronous machine. According to one exemplary embodiment, the electric machine M can also be an asynchronous machine. The device 100 and the electric machine M are connected to one another for signal transmission.

The device 100 has a regulator 110, an input point 120, an actuator 130, a first return unit 140 and a second return unit 160. The regulator 110 is in the form of a PI regulator, for example. The input point 120 is electrically interconnected between the regulator 110 and the actuator 130. The actuator 130 is electrically connected to the regulator 110 at the input side via the input point 120, and can be electrically connected to the electric machine M at the output side. In the illustration in FIG. 1, the electric machine M is connected to the actuator 130. An electric detection signal 125 can be input at the input point 120. The electric detection signal 125 represents an input voltage Vᵢₙⱼ at the point Ok. More precisely, the electric detection signal 125 can be added to a regulator output signal 115 at the input point 120. The regulator output signal 115 represents an actuating variable for the device 100. The actuator 130 is configured to output an output signal 138. The output signal 138 of the actuator 130 represents a control variable for the device 100.

The first return unit 140 is electrically connected in parallel to the regulator 110 and the actuator 130. The first return unit 140 is configured to return a first return signal 148 to the regulator 110. The first return signal 148 represents a version of an output signal 138 of the actuator 130 that has been transformed and processed by the first return unit 140.

The second return unit 160 is electrically connected in parallel to the first return unit 140. The second return unit 160 is configured to return at least a second return signal 165 to the first return unit 140 and/or the actuator 130. The second return signal 165 represents a version of the output signal 138 of the actuator 130 that has been transformed by the first return unit 140 and processed by the second return unit 160. The second return signal 165 represents an angle or estimated angle \hat{θ} between the rotor and the stator of the electric machine M.

According to the exemplary embodiment of the present invention shown in FIG. 1, the actuator 130 has an electric series connection. A signal transformer 132 for transforming a rotor coordinate system (dq) into a stator coordinate system (αβ), a pulse width modulating device 134, and a converter 136 for providing the output signal 138 of the actuator 130 are connected in series for this. The signal transformer 132 is configured to receive the second return signal 165 from the second return unit 160.

According to the exemplary embodiment of the present invention shown in and described in reference to FIG. 1, the first return unit 140 contains a first signal transformer 142, a second signal transformer 152, a signal reconstruction device 154, a third signal transformer 156, a fourth signal transformer 146, and a subtraction point 144.

The first signal transformer 142 is configured to transform a coordinate system (abc) relating to phases of the electric machine M into a stator coordinate system (αβ). The first signal transformer 142 is configured to execute the transformation on the output signal 138 of the actuator 130. Furthermore, the first signal transformer 142 is configured to provide or output a transformed output signal 143 or a measured output signal 143. The first signal transformer 142 is connected at the output side to the second signal transformer 152 and the subtraction point 144 for signal transmission.

The second signal transformer 152 is configured to further transform the transformed output signal 153 from a stator coordinate system (αβ) into a rotor coordinate system (dq). The second signal transformer 152 is also configured to receive an angle signal 151 (θₖ). The second signal transformer 152 is also configured to provide or output a further transformed output signal 153. The second signal transformer 152 is connected at the output side to the signal reconstruction device 154 and the second return unit 160 for signal transmission. The signal reconstruction device 154 is configured to generate a reconstructed version of the output signal 138 of the actuator based on the further transformed output signal 153.

The third signal transformer 156 is connected to the signal reconstruction device 154 for signal transmission. The third signal transformer 156 is configured to transform the version of the output signal 138 of the actuator reconstructed by means of the signal reconstruction device 154 from a rotor coordinate system (dq) into a stator coordinate system (αβ). The third signal transformer 156 is also configured to receive the angle signal 151 (θₖ). The third signal transformer 156 is connected at the output side to the subtraction point 144 for signal transmission. An output signal from the third signal transformer 156 is subtracted from the transformed output signal 143, or from the measured output signal 143 from the first signal transformer 142, at the subtraction point 144.

The fourth signal transformer 146 is connected to the first signal transformer 142 and the third signal transformer 156 for signal transmission. In other words, the fourth signal transformer 146 is connected to the subtraction point 144. The fourth signal transformer 146 is configured to transform an output signal from the subtraction point 144 from a stator coordinate system (αβ) into a rotor coordinate system (dq), in order to generate the first return signal 148. The fourth signal transformer 146 is connected at the output side to the regulator 110 for signal transmission. More precisely, the fourth signal transformer 146 is connected at the output side to a further subtraction point 105 for signal transmission. The first return signal 148 is subtracted from the reference signal 175 at the further subtraction point 105. The reference signal 175 represents a reference variable for the device 100.

According to one exemplary embodiment, the signal reconstruction device 154 is in the form of a Kalman filter. The first return unit 140 is configured in this case to subtract the version of the output signal 138 of the actuator 130 reconstructed by means of the signal reconstruction device 154 from the transformed output signal 143 or the measured output signal 143, i.e. from a measured version of the output signal 138 of the actuator 130.

According to one exemplary embodiment, the signal reconstruction device 154 is configured to reconstruct the output signal 138 of the actuator 130 based on an input frequency of the detection signal 125 and a matrix stored in the form of a reference table. This shall be explained in greater detail below.

According to the exemplary embodiment of the present invention illustrated in FIG. 1, the second return unit 160 has a demodulation device 162 and a model surveillance device 164. The demodulation device 162 is configured to demodulate the further transformed output signal 153 from the second signal transformer 152 of the first return unit 140, i.e. the version of the output signal 138 of the actuator 130 transformed by the first return unit 140. The model surveillance device 164 is configured to generate the second return signal 165 based on at least a demodulation signal 163 or output signal 163 of the demodulation device 162. The demodulation signal 163 represents an error ε or an error signal. More precisely, the model surveillance device 164 is configured to also generate the second return signal 165 based on an electric voltage signal V_{αβ} and an electric current signal I_{αβ}. The electric voltage signal V_{αβ} and the electric current signal I_{αβ} are plotted in the stator coordinate system (αβ).

Optionally, the device 100 contains a reference signal generating unit 170 upstream of the regulator 110 for generating the reference signal 175 for the regulator 110 and/or a speed control unit 180 upstream of the regulator 110. The reference signal 175 is a current signal in particular. In this case, the second return unit 160 is configured to return a third return signal 166 to the reference signal generating unit 170 and/or to the speed control unit 180. The third return signal 166 represents an angular speed, or estimated angular speed \acute{ω} of the rotor in relation to the stator in the electric machine M. The reference signal generating unit 170 and the speed control unit 180 are connected in series. The reference signal generating unit 170 is connected to the regulator for signal transmission via the further subtraction point 105. The reference signal generating unit 170 is interconnected electrically between the speed control unit 180 and the further subtraction point 105. The speed control unit 180 is interconnected electrically between an additional subtraction point 190 and the reference signal generating unit 170. The speed control unit 180 is configured to generate a target signal 185 (T_{ref}) for the reference signal generating unit 170. The third return signal 166 is subtracted from a further reference signal 195 at the additional subtraction point 190. The further reference signal 195 represents a reference variable in the form of a reference angular speed ω_{ref}. As a result, the third return signal 166 can be received at the reference signal generating unit 170, as well as, optionally, at the additional subtraction point 190.

In other words, FIG. 1 shows a schematic illustration of the device 100 that has an auto-detection strategy with a field-oriented regulator. An algorithm for estimating the rotor position in a synchronous machine or a permanent magnet synchronous machine forming the electric machine M is implemented or carried out, for example, in the device 100, in particular at low speeds or rotational rates. It is assumed here, that the drive system, or the device 100, powers a synchronous machine that has a field-oriented control. FIG. 1 shows a schematic illustration of such a device 100, which has an optional speed control loop.

The signal feed of the detection signal 125 is carried out, for example, in an estimated reference frame that has a selected angle θₖ between the signal and the estimated d-axis. The input can be in the form of a square wave or a sine wave. A current response is reconstructed by means of the signal reconstruction device 154 using a Kalman filter, and subtracted from the measured output signal 143 or the measured current, which is then returned to the regulator 110. The Kalman filter is derived as follows:

The current response is a sum of the pulse background or the fundamental current and the high frequency response of the electric machine M to the voltage input or the input of the detection signal 125.

S=S_{fundamental}+S_{hf}

S_{hf}=Acos (2πƒᵢₙⱼt+θ_{d})=a₁ cos (2πƒᵢₙⱼt)−a₂ sin (2πƒᵢₙⱼt)

The input frequency fᵢₙⱼ is known, and the angle θ_{d} is a phase delay, and a₁ and a₂ are real values.

$$X = [ \begin{matrix}{a}_{1} \\ {a}_{2}\end{matrix} ] and H = [ cos ( 2 π {f}_{inj} t ) - sin ( 2 π {f}_{inj} t ) ] .$$

Model and measurement equations can be written as follows, assuming a stationary operation:

Xₙ=Xₙ₋₁

Yₙ=HₙXₙ+vₙ

Yₙ is an n^{th} measurement value and vn is a measurement noise.

It should be noted that due to the implementation of this equation in time-discrete regulators, the matrix H is stored as a reference table, and its actual value is updated with each iteration based on this reference table. This reduces computing time.

The vector X is updated on the basis of the following equation:

Xₙ=Xₙ₋₁+Kₙ(Yₙ−HₙXₙ₋₁)

where

Kₙ=Pₙ₋₁Hₙ^{T}Sₙ⁻¹

Sₙ=HₙPₙ₋₁Hₙ^{T}+Rₙ

Pₙ=(I−KₙHₙ)Pₙ₋₁

This formulation can be expanded to identify other frequencies in the signal, e.g. the 3^{rd} harmonic in a square wave input. Only the vectors X and H need to be adjusted. The filtering is then carried out in that the estimated signal is subtracted from the measured signal. The advantage with this filtering is that the phase delays or bandwidth limitations of the feedback control loop are prevented.

FIG. 2 shows a schematic illustration of a demodulation device 162 in the device shown in FIG. 1. The demodulation device 162 is configured to generate the demodulation signal 163 for output to the model surveillance device using the further transformed output signal 153 from the second signal transformer of the first return unit in the device.

For this, the demodulation device 162 has a bandpass filter 201, a sign function unit 204 (sgn), a multiplication unit 206, a correction unit 208, and optionally, a lowpass filter 209. The bandpass filter 201 is centered on an input frequency fᵢₙⱼ of the detection signal. The bandpass filter 201 is configured to filter the further transformed output signal 153, or the version of the output signal of the actuator formed by the first return unit. The bandpass filter 201 is configured to provide or output a first filter signal 202 (i_{cd}) and a second filter signal 203 (i_{cq}).

The sign function unit 204 is connected to the bandpass filter 201 for signal transmission. The sign function unit 204 is configured to receive the first filter signal 202 from the bandpass filter 201. The multiplication unit 206 is connected to the bandpass filter 201 and the sign function unit 204 for signal transmission. The multiplication unit 206 is configured to multiply the second filter signal 203 from the bandpass filter 201 and a version of the first filter signal 202 processed by means of the sign function unit 204 with one another in order to generate a multiplication signal 207.

The correction unit 208 is connected to the multiplication unit 206 for signal transmission. The correction unit 208 is configured to receive the multiplication signal 207 from the multiplication unit 206. The correction unit 208 is configured to use a correction factor k based on the input detection signal, more precisely, to use it on the multiplication signal 207. The optional lowpass filter 209 is connected to the correction unit 208 for signal transmission. The correction unit 208 is electrically interconnected between the multiplication unit 206 and the lowpass filter 209. The lowpass filter 209 is configured according to one exemplary embodiment to provide or output the demodulation signal 163.

In other words, the demodulation is carried out in the estimated frame, as shown in FIG. 2. The bandpass filter 201 is centered on the input frequency, and the sign function unit 204 is configured to execute a function that outputs the sign of the input signal, or the further transformed output signal 153. The parameter-based factor or correction factor k can be adjusted to maintain a constant a bandwidth of a cascaded regulator, even if there are saturation effects and changes in the voltage supply.

According to another exemplary embodiment, the demodulation device 162 can have another suitable structure.

FIG. 3 shows a schematic illustration of a model surveillance device 164 of the device in FIG. 1. The model surveillance device 164 is configured to generate the second return signal 165 and potentially or optionally the third return signal 166 based on the demodulation signal 163 from the demodulation device in FIG. 2, the electric current signal I_{αβ} and the electric voltage signal V_{αβ}.

For this, the model surveillance device 164 contains a model regulator 301, a first connection point 302, an R-unit 303, an Lq-unit 304, a delay element 306 (1/s), a second connection point 307, and an output element 308. The model regulator 301 is configured to receive or input the demodulation signal 163. The model regulator 301 is connected at the output side to the first connection point 302 for signal transmission.

The R-unit 303 and the Lq-unit 304 are configured to receive or input the electric current signal I_{αβ}. The R-unit 303 is connected at the output side to the first connection point 302. The Lq-unit 304 is connected at the output side to the second connection point 307. The electric voltage signal V_{αβ} is added to an output signal of the model regulator 301 and an output signal of the R-unit 303 is subtracted from the output signal of the model regulator 301 at the first connection point. The first connection point 302 is connected to the delay element 306 for signal transmission. The delay element 306 is electrically interconnected between the first connection point 302 and the second connection point 307.

An output signal of the L-unit 304 is subtracted from an output signal of the delay element 306 at the second connection point 307. The output element 308 is connected to the second connection point 307 for signal transmission. The output element 308 has a phase control loop or a mechanical monitor. The output element 308 is configured to provide or output the second return signal 165 and potentially, or optionally, the third return signal 166.

In other words, the model surveillance device 164 is designed as a hybrid surveillance device for mixing (blending) estimated values. The error signal or demodulation signal 163 determined by means of the demodulation device is sent to the model surveillance device 164 or the voltage model surveillance device. An angle determined by the signal input element is dominant in a stationary operating state, and an angle determined by the voltage model is dominant in transition states (transient states). A flux determined as the output of the voltage model or the model surveillance device 164 is sent to a phase control loop (PLL, phase-locked loop) or a mechanical monitor of the output element 308 in order to determine and smooth the angle formation and speed data or rotational rate data represented by the second return signal 165 and the third return signal 166.

According to another exemplary embodiment, the model surveillance device 164 can have another suitable structure.

FIG. 4 shows a flow chart for a control method 400 in accordance with an exemplary embodiment. The control method 400 can be executed in order to control the operation of an electric machine. The control method 400 can be executed in conjunction with the device in FIG. 1, or a similar device. The electric machine has a rotor and a stator.

In the input step 410 an electric detection signal is input in the control method 400 at an input point that is electrically interconnected between a regulator and an actuator. The actuator is connected electrically to the regulator at the input side, and can be connected electrically to the electric machine at the output side.

In a subsequent processing step 420 an output signal of the actuator is processed in the control method 400 with a first return unit and a second return unit. The first return unit is electrically connected in parallel to the regulator and the actuator, and the second return unit is electrically connected in parallel to the first return unit. The processing step 420 can be executed in order to return a first return signal from the first return unit to the regulator. The first return signal represents a version of an output signal of the actuator transformed and processed by the first return unit. Furthermore, the processing step 420 can be executed in order to return at least a second return signal from the second return unit to the first return unit and/or the actuator. The second return signal represents a version of the output signal of the actuator transformed by the first return unit and processed by the second return unit. In addition, the second return signal represents an angle between the rotor and the stator in the electric machine.

According to an exemplary embodiment, other appropriate methods can be used to trace a sine curve of a known frequency.

The exemplary embodiments shown in the figures and described in reference thereto are selected merely by way of example. Different exemplary embodiments can be combined with one another in their entirety or with respect to individual features. An exemplary embodiment can also be supplemented by features of another exemplary embodiment.

Furthermore, method steps can be repeated or executed in a sequence other than that described herein.

If an exemplary embodiment comprises an “and/or” conjunction between a first feature and a second feature, this can be read to mean that the exemplary embodiment according to one embodiment contains both the first feature and the second feature, and contains either just the first feature or just the second feature according to another embodiment.

### REFERENCE SYMBOLS

100 device

105 further subtraction point

110 regulator

115 regulator output signal

120 input point

125 electric detection signal

130 actuator

132 signal transformer

134 pulse width modulation device

136 converter

138 output signal

140 first return unit

142 first signal transformer

143 transformed output signal or measured output signal

144 subtraction point

146 fourth signal transformer

148 first return signal

151 angle signal

152 second signal transformer

153 further transformed output signal

154 signal reconstruction device

156 third signal transformer

160 second return unit

162 demodulation device

163 demodulation signal

164 model surveillance device

165 second return signal

166 third return signal

170 reference signal

175 control signal

180 speed control unit

185 target signal

190 additional subtraction point

195 further reference signal

abc coordinate system relating to phases of the electric machine M

αβ stator coordinate system

dq rotor coordinate system

I_{αβ} electric current signal

M electric machine

V_{αβ} electric voltage signal

201 bandpass filter

202 first filter signal

203 second filter signal

204 sign function unit

206 multiplication unit

207 multiplication signal

208 correction unit

209 lowpass filter

301 model regulator

302 first connection point

303 R-unit

304 Lq-unit

306 delay element

307 second connection point

308 output element

400 control method

410 input step

420 processing step

1. A device for controlling the operation of an electric machine, wherein the electric machine contains a rotor and a stator, wherein the device comprises:
a regulator;
an actuator, wherein the actuator is configured to be electrically connected at an input side to the regulator and is configured to be connected electrically to the electric machine at an output side;
an input point, wherein the input point is electrically interconnected between the regulator and the actuator, wherein an electric detection signal can be input at the input point;
a first return unit for returning a first return signal to the regulator, wherein the first return unit is connected in parallel to the regulator and the actuator, wherein the first return signal represents a version of an output signal of the actuator transformed and processed by the first return unit; and
a second return unit for returning at least one second return signal to at least one of the first return unit or the actuator, wherein the second return unit is connected in parallel to the first return unit, wherein the second return signal represents a version of the output signal of the actuator transformed by the first return unit and processed by the second return unit, wherein the first return signal represents an angle between the rotor and the stator in the electric machine.

2. The device according to claim 1, wherein the second return unit contains a demodulation device and a model surveillance device, wherein the demodulation device is configured to demodulate the version of the output signal of the actuator transformed by the first return unit, and wherein the model surveillance device is configured to generate at least the second return signal based on an output signal of the demodulate device.

3. The device according to claim 2, wherein the demodulation device contains a bandpass filter centered on an input frequency of the detection signal for filtering the version of the output signal of the actuator transformed by the first return unit, a sign function unit connected to the bandpass filter for signal transmission, a multiplication unit connected to the bandpass filter and the sign function unit for signal transmission, and a correction unit connected to the multiplication unit for signal transmission in order to use a correction factor based on the detection signal, wherein the demodulation device also, contains a lowpass filter connected to the correction unit for signal transmission.

4. The device according to claim 2, wherein the model surveillance device contains a model regulator, a delay element and an output element, wherein the output element contains a phase control loop or a mechanical monitor.

5. The device according to claim 1, wherein the second return unit is configured to return a third return signal to at least one of a reference signal generating unit upstream of the regulator to generate a reference signal for the regulator or a speed control unit upstream of the regulator, wherein the third return signal represents an angular speed of the rotor in relation to the stator in the electric machine.

6. The device according to claim 1, wherein the first return unit contains a first signal transformer for transforming a coordinate system relating to phases (abc) of the electric machine into a stator coordinate system (αβ), a second signal transformer connected to the first signal transformer for signal transmission for transforming a stator coordinate system (αβ) into a rotor coordinate system (dq), a signal reconstruction device connected to the second signal transformer for signal transmission for reconstructing the output signal of the actuator, a third signal transformer connected to the signal reconstruction device for transforming a rotor coordinate system (dq) into a stator coordinate system (αβ), and a fourth signal transformer connected to the first signal transformer and the third signal transformer for signal transmission for transforming a stator coordinate system (αβ) into a rotor coordinate system (dq).

7. The device according to claim 6, wherein the signal reconstruction unit is configured to subtract a version of the output signal of the actuator reconstructed by means of the signal reconstruction unit from a measured version of the output signal of the actuator.

8. The device according to claim 6, wherein the signal reconstruction device is configured to reconstruct the output signal of the actuator based on an input frequency of the detection signal and a matrix stored in the form of a reference table.

9. The device according to claim 1, wherein the actuator contains a series circuit that contains a signal transformer for transforming a rotor coordinate system (dq) into a stator coordinate system (αβ), a pulse width modulation device and a converter for providing the output signal of the actuator unit, wherein the second return signal can be received by the signal transformer.

10. A method for controlling the operation of an electric machine, wherein the electric machine contains a rotor and a stator, wherein the method comprises:
inputting an electric detection signal at an input point that is electrically interconnected between a regulator and an actuator, wherein the actuator is configured to be connected electrically to the regulator at an input side, and is configured to be connected electrically to the electric machine at an output side; and
processing an output signal of the actuator using a first return unit and a second return unit, wherein the first return unit is connected in parallel to the regulator and the actuator, wherein the second return unit is connected in parallel to the first return unit in order return a first return signal from the first return unit to the regulator, wherein the first return signal represents a version of an output signal of the actuator transformed and processed by the first return unit, and at least a second return signal from the second return unit to at least one of the first return unit or the actuator, wherein the second return signal represents a version of the output signal of the actuator transformed by the first return unit and processed by the second return unit, wherein the second return signal represents an angle between the rotor and the stator in the electric machine.

11. A non-transitory machine readable storage medium having stored therreon a computer program that, when executed by at least one processing device, is configured to cause the at least one processing device to perform the method according to claim 10.

12. (canceled)
